(19) United States
(12) Patent Application Publication
(10) Pub. No.: US 2020/0307591 A1
(43) Pub. Date: Oct. 1, 2020

(54) VEHICLE CONTROL APPARATUS, VEHICLE CONTROL METHOD, VEHICLE, AND NON-TRANSITORY COMPUTER-READABLE STORAGE MEDIUM

(71) Applicant: HONDA MOTOR CO., LTD., Tokyo (JP)

(72) Inventors: Yuko OUCHI, Wako-shi (JP); Tomoaki YAMABE, Wako-shi (JP); Daichi KATO, Wako-shi (JP)

(21) Appl. No.: 16/807,474

(22) Filed: Mar. 3, 2020

(30) Foreign Application Priority Data
Mar. 27, 2019 (JP) 2019-061295

(51) Int. Cl. B60W 30/18; B60W 40/04; B60W 50/08

(52) U.S. Cl. CPC B60W 30/18163; B60W 50/082; B60W 40/04

(57) ABSTRACT

A vehicle control apparatus that controls a vehicle, comprising: an acquisition unit configured to acquire peripheral information of the vehicle; and a control unit configured to control traveling of the vehicle based on the peripheral information, wherein the control unit determines whether the vehicle is traveling on a main lane, if the vehicle is traveling on a main lane, executes control in which both first course change control and second course change control, in which an automation rate is lower than in the first course change control or a degree of involvement in vehicle operations required of a driver is increased, are executable, and if the vehicle is not traveling on the main lane, executes control in which the second course change control is executable but the first course change control is not executable.

### CROSS-REFERENCE TO RELATED APPLICATION

This application claims priority to and the benefit of Japanese Patent Application No. 2019-061295 filed on Mar. 27, 2019, the entire disclosure of which is incorporated herein by reference.

### BACKGROUND OF THE INVENTION

### Field of the Invention

The present invention relates to a vehicle control apparatus, a vehicle control method, a vehicle, and a non-transitory computer-readable storage medium, and more specifically, a vehicle control technique of an automated driving vehicle.

### Description of the Related Art

International Publication No. 2018/123346 discloses that after automated driving is started, an automated lane change is suppressed until a predetermined time elapses or until the vehicle travels a predetermined distance. This makes it possible to smoothly switch from manual driving to automated driving without a sense of incongruity.

However, the conventional technique has a problem that it does not consider adaptive control of the degree of automation of automated driving in accordance with the road on which the vehicle is travelling.

The present invention has been made in consideration of the above problem, and provides a technique for implementing adaptive automated driving with further improved safety.

### SUMMARY OF THE INVENTION

According to one aspect of the present invention, there is provided a vehicle control apparatus that controls a vehicle, comprising: an acquisition unit configured to acquire peripheral information of the vehicle; and a control unit configured to control traveling of the vehicle based on the peripheral information, wherein the control unit determines whether the vehicle is traveling on a main lane, if the vehicle is traveling on a main lane, executes control in which both first course change control and second course change control, in which an automation rate is lower than in the first course change control or a degree of involvement in vehicle operations required of a driver is increased, are executable, and if the vehicle is not traveling on the main lane, executes control in which the second course change control is executable but the first course change control is not executable.

### BRIEF DESCRIPTION OF THE DRAWINGS

The accompanying drawings, which constitute a part of the specification, illustrate embodiments of the invention and, together with the description, serve to explain the invention.

FIG. 1 is a view for explaining an arrangement example of a vehicle according to an embodiment;

FIG. 2 is a block diagram for explaining the arrangement example of the vehicle according to the embodiment;

FIG. 3 is a flowchart for explaining an example of the procedure of processing performed by a control apparatus according to the embodiment; and

FIG. 4 is a view explaining a main lane, a branch lane, and a merging lane of an expressway according to the embodiment.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar arrangements, and redundant description thereof is omitted.

<Vehicle Arrangement>

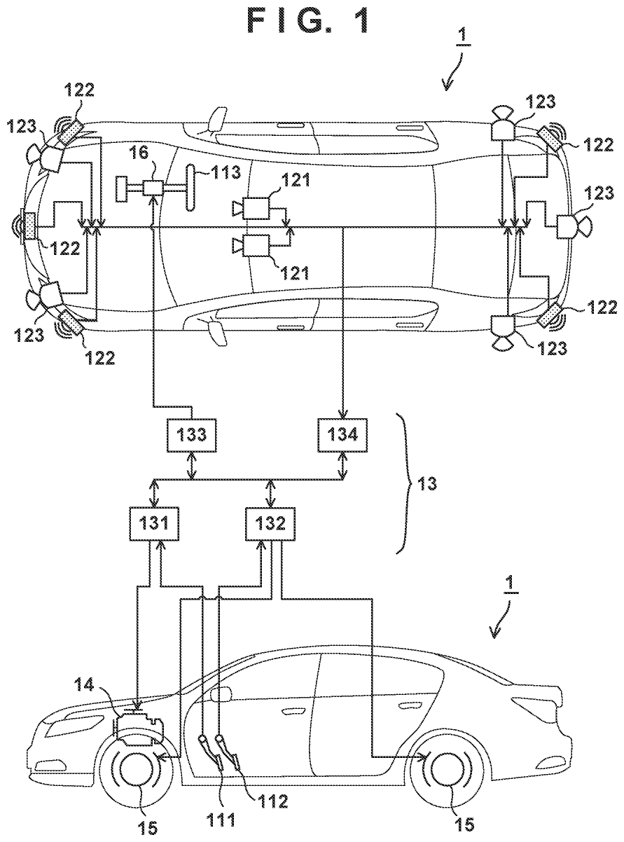

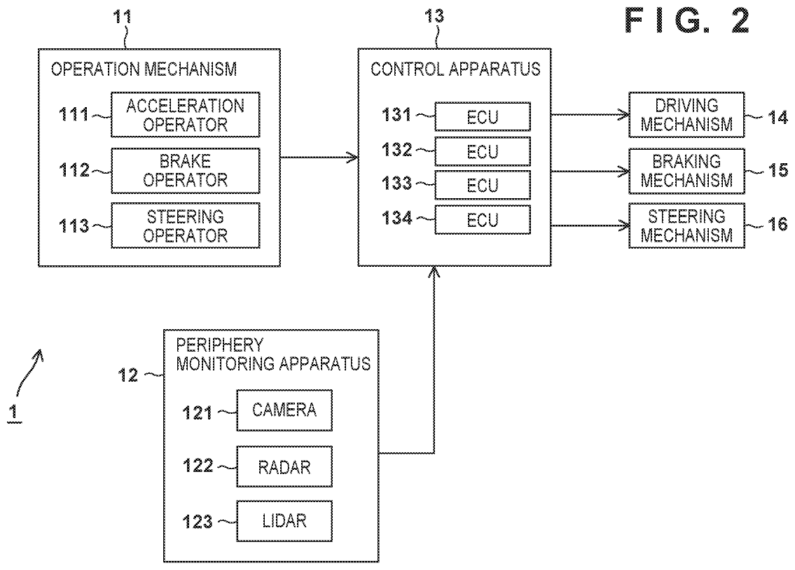

FIGS. 1 and 2 are views for explaining the arrangement of a vehicle 1 according to the first embodiment. FIG. 1 shows the installation positions of elements to be explained below and the connection relationships between the elements by using a top view and a side view of the vehicle 1. FIG. 2 is a system block diagram of the vehicle 1.

Note that in the following explanation, expressions such as front/rear, upper/lower, and lateral (left/right) will be used in some cases in order to indicate relative directions based on the vehicle body of the vehicle 1. For example, “front” indicates the front in the front-and-rear direction of the vehicle body, and “upper” indicates the direction of height of the vehicle body.

The vehicle 1 includes an operation mechanism 11, a periphery monitoring apparatus 12, a vehicle control apparatus 13, a driving mechanism 14, a braking mechanism 15, and a steering mechanism 16. Note that the vehicle 1 is a four-wheeled car in this embodiment, but the number of wheels is not limited to this.

The operation mechanism 11 includes an acceleration operator 111, a brake operator 112, and a steering operator 113. Typically, the acceleration operator 111 is an accelerator pedal, the brake operator 112 is a brake pedal, and the steering operator 113 is a steering wheel. However, each of the operators 111 to 113 may also be another type of an operator such as a lever type operator or a button type operator.

The periphery monitoring apparatus 12 includes cameras 121, radars 122, and LiDARs (Light Detection and Ranging) 123, all of which function as sensors for monitoring or detecting the peripheral environment of the vehicle (self-vehicle) 1. The camera 121 is an imaging device using, for example, a CCD image sensor or a CMOS image sensor. The radar 122 is a distance measurement device such as a millimeter-wave radar. The LiDAR 123 is a distance measurement device such as a laser radar. As exemplarily shown in FIG. 1, these devices are arranged in positions where the peripheral environment of the vehicle 1 can be detected, for example, on the front side, rear side, upper side, and lateral sides of the vehicle body.

Examples of the peripheral environment of the vehicle 1 described above are the traveling environment of the vehicle 1 and the related peripheral environments (for example, the extending direction of a traffic lane, a travelable region, and the color of a traffic signal) of the vehicle 1, and peripheral object information (for example, the presence/absence of an object such as another vehicle, a pedestrian, or an obstacle, and the attribute, the position, and the direction and speed of the movement of the object) of the vehicle 1. From this viewpoint, the periphery monitoring apparatus 12 can also be expressed as a detection device for detecting peripheral information of the vehicle 1.

The vehicle control apparatus 13 is capable of controlling the vehicle 1 and, for example, controls the mechanisms 14 to 16 based on signals from the operation mechanism 11 and/or the periphery monitoring apparatus 12. The vehicle control apparatus 13 includes ECUs (Electronic Control Units) 131 to 134. Each ECU includes a CPU, a memory, and a communication interface. Each ECU causes the CPU to perform predetermined processing based on information (data or an electrical signal) received via the communication interface, stores the processing result in the memory, or outputs the processing result to another element via the communication interface.

The ECU 131 is an acceleration ECU and, for example, controls the driving mechanism 14 (to be described later) based on the amount of operation of the acceleration operator 111 performed by the driver. The ECU 132 is a braking ECU and, for example, controls the braking mechanism 15 based on the amount of operation of the brake operator 112 performed by the driver. The braking mechanism 15 is, for example, a disk brake formed in each wheel. The ECU 133 is a steering ECU and, for example, controls the steering mechanism 16 based on the amount of operation of the steering operator 113 performed by the driver. The steering mechanism 16 includes, for example, a power steering.

The ECU 134 is an analytical ECU installed for the periphery monitoring apparatus 12. The ECU 134 performs predetermined analysis/processing based on the peripheral environment of the vehicle 1 obtained by the periphery monitoring apparatus 12, and outputs the result to the ECUs 131 to 133.

That is, the ECUs 131 to 133 can control the mechanisms 14 to 16 based on signals from the ECU 134. With this arrangement, the vehicle control apparatus 13 can control traveling of the vehicle 1 in accordance with the peripheral environment, for example, can perform automated driving.

In this specification, automated driving is a state in which the vehicle control apparatus 13 performs some or all of the driving operations (acceleration, barking, and steering), instead of the driver. That is, the concept of automated driving includes a form (so-called complete automated driving) in which the vehicle control apparatus 13 performs all of the driving operations, and a form (so-called drive assist) in which the vehicle control apparatus 13 performs only some of the driving operations. Examples of drive assist are a speed control (auto cruise control) function, an inter-vehicle distance control (adaptive cruise control) function, a lane departure prevention assist (lane keep assist) function, and a collision avoidance assist function.

Note that the vehicle control apparatus 13 is not limited to this arrangement. For example, a semiconductor device such as an ASIC (Application Specific Integrated Circuit) may also be used as each of the ECUs 131 to 134. That is, the functions of the ECUs 131 to 134 can be implemented by either hardware or software. Also, some or all of the ECUs 131 to 134 can be configured by a single ECU.

<Traveling Control>

In this embodiment, the vehicle control apparatus 13 can execute a plurality of traveling control operations. The plurality of traveling control operations are classified into a plurality of stages depending on the degree of automation (automation rate) in vehicle control and the degree of tasks required of a vehicle passenger (driver) (the degree of involvement in vehicle operations of the vehicle passenger).

For each of the plurality of traveling control operations, vehicle control related to acceleration, deceleration, steering including a lane change, braking, and the like of the vehicle, and tasks required of a vehicle passenger (driver) are set. The tasks required of the vehicle passenger include operations required of the vehicle passenger to cope with a request of monitoring the periphery of the vehicle, such as gripping a steering wheel (hands-off or hands-on), monitoring the periphery (eyes-off or eyes-on), and changing the driving subject.

The vehicle control apparatus 13 can perform automated driving traveling of the vehicle 1 by any one of the plurality of traveling control operations based on information (external information) on the peripheral environment of the vehicle 1 acquired by the periphery monitoring apparatus 12.

First traveling control is traveling control in which the automation rate is relatively low or the degree of involvement in vehicle operations required of the driver is relatively increased. In the first traveling control, the driving subject of the vehicle 1 is the driver, and the driver is required to monitor the periphery and grip the steering wheel. The first traveling control is, for example, control that can be executed on a general road departed from an expressway. In the first traveling control, drive assist such as a speed control (auto cruise control) function, an inter-vehicle distance control (adaptive cruise control) function, a lane departure prevention assist (lane keep assist) function, and a collision avoidance assist function may be performed.

Second traveling control is traveling control in which the automation rate is relatively high or the degree of involvement in vehicle operations required of the driver is relatively decreased. In the second traveling control, the driving subject of the vehicle 1 is the vehicle control apparatus 13 (vehicle system), and the driver is required to monitor the periphery but need not grip the steering wheel. However, during the second traveling control, the driver is required to be prepared for gripping the steering wheel in response to notification of a steering wheel gripping request from the vehicle control apparatus 13 (vehicle system). The second traveling control is, for example, control that can be executed on the main lane of an expressway.

Note that, in addition to the second traveling control, traveling control in which driver's duty of monitoring the periphery is mitigated only in a specific scene may be executed. In that case, the driver need not monitor the periphery, but is required to monitor the system in case the specific scene ends or the vehicle control apparatus 13 (vehicle system) becomes abnormal. The specific scene is, for example, a traffic jam on the main lane of an expressway.

The first traveling control and the second traveling control are required to have relatively different automation rates or relatively different degrees of involvement in vehicle operations required of the driver, and the specific contents of each traveling control are not limited.

<Course Change Control>

Further, in this embodiment, the vehicle control apparatus 13 can execute a plurality of course change control operations including first course change control and second course change control. The first course change control is, for example, automated lane change control initiated by the system, that is, control in which the vehicle control apparatus 13 executes a lane change based on self-determination. The second course change control is, for example, automated driving control initiated by a vehicle passenger (driver), that is, control in which the vehicle control apparatus 13 performs an automated lane change when it is instructed by the vehicle passenger (driver). The second course change control is course change control in which the automation rate is lower than in the first course change control or the degree of involvement in vehicle operations required of the driver is increased.

In this embodiment, in the first traveling control, control is executed in which the first course change control is not executable but the second course change control is executable. In the second traveling control, control is executed in which both the first course change control and the second course change control are executable.

The contents of the executable traveling control can be selected in accordance with the location where the vehicle 1 is traveling. For example, if the vehicle 1 is traveling on the main lane of an expressway, control is executed in which both the first course change control and the second course change control are executable. If the vehicle 1 is traveling on a location (for example, a branch lane or a merging lane) other than the main lane of an expressway, in order to suppress inadvertent lane changes, the first course change control may be inhibited and the second course change control may be permitted. Note that determination as to whether a certain road is the main lane, the branch lane, or the merging lane can be performed based on, for example, the number of traffic lanes, and it can be determined that the road with the larger number of traffic lanes is the main lane.

<Processing>

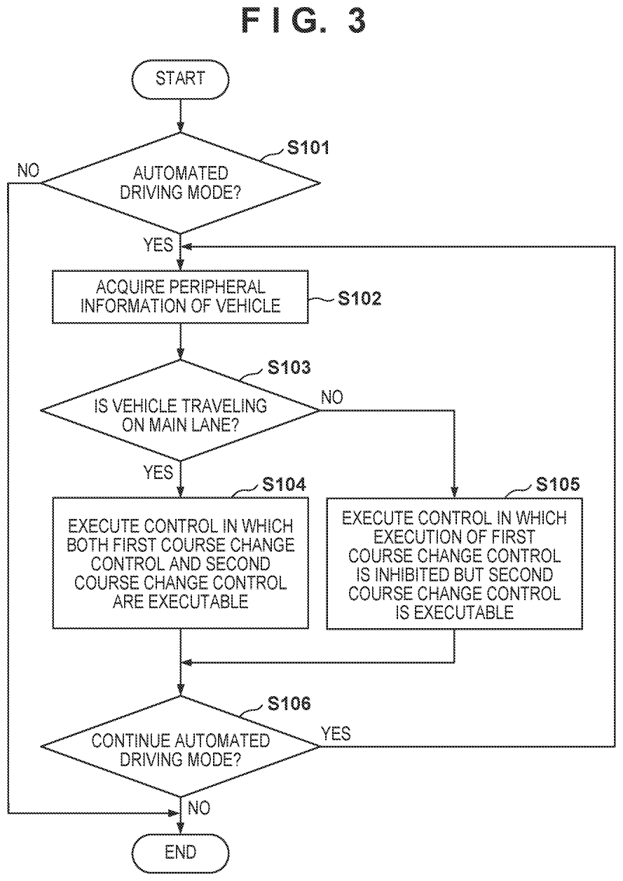

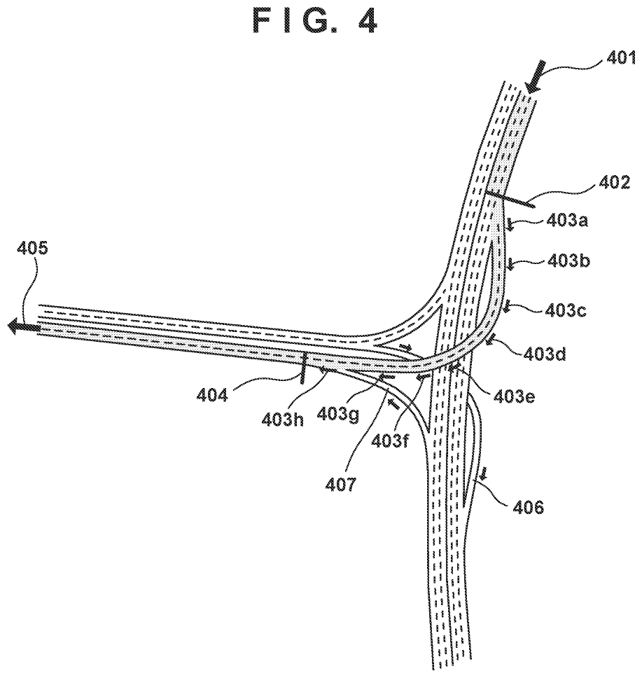

Next, the details of processing according to this embodiment will be described with reference to FIGS. 3 and 4. FIG. 3 is a flowchart for explaining an example of the procedure of the vehicle control according to this embodiment. FIG. 4 is a view explaining a main lane, a branch lane, and a merging lane of an expressway on which the vehicle 1 travels according to this embodiment.

In step S101 (this is simply referred to as “S101” hereinafter, and the same applies to other steps) of FIG. 3, the vehicle control apparatus 13 determines whether the operation mode of the vehicle 1 is the automated driving mode. If it is the automated driving mode, the process advances to S102. Otherwise (if it is the normal mode in which all of the driving operations are performed by the driver), this procedure is terminated. Note that switching between the normal mode and the automated driving mode as the operation mode of the vehicle 1 can be performed when the driver (or a person who can be a driver when automated driving is canceled) presses a predetermined switch in the vehicle.

In S102, the vehicle control apparatus 13 acquires the peripheral information of the vehicle 1. This step is performed by the ECU 134 of the vehicle control apparatus 13 receiving the peripheral information of the vehicle 1 detected by the periphery monitoring apparatus 12. The vehicle control apparatus 13 controls the operation of the vehicle 1 based on the peripheral information.

In S103, the vehicle control apparatus 13 determines whether the vehicle 1 is traveling on the main lane of an expressway. As for the position of the vehicle 1, by using the self-position information acquired by a GPS sensor (not shown) provided in the vehicle 1 and collating the self-position with map information stored in advance, it can be determined whether the vehicle 1 is traveling on the main lane. If it is determined that the vehicle 1 is traveling on the main lane, the process advances to S104. On the other hand, if it is determined that the vehicle 1 is not traveling on the main lane, that is, if it is determined that the vehicle 1 is traveling on a location (a branch lane or a merging lane) other than the main lane, the process advances to S105.

Here, a description will be made with reference to FIG. 4. In FIG. 4, the vehicle 1 travels on the main lane of the expressway in the direction indicated by an arrow 401, and changes its course to a branch lane at a branch point 402. Then, the vehicle 1 travels on the branch lane along arrows 403a to 403h, passes a junction 404, and travels on the main lane again to travel in the direction indicated by an arrow 405. In the example shown in FIG. 4, the vehicle 1 travels on the main lane or the branch lane, and the determination result is acquired in S103 in accordance with the location where the vehicle 1 is traveling. Note that in the example shown in FIG. 4, each of a lane 406 and a lane 407 is a branch lane that branches off from the main lane and is also a merging lane that merges the main lane.

In S104, the vehicle control apparatus 13 executes control in which both the first course change control and the second course change control are executable. In this manner, if the vehicle is traveling on the main lane of the expressway as described above, in order to enable free automated lane changes, control is executed in which both the first course change control and the second course change control are executable.

In S105, the vehicle control apparatus 13 executes control in which execution of the first course change control is inhibited but the second course change control is executable. If the vehicle 1 is not traveling on the main lane of the expressway, that is, if the vehicle 1 is traveling on a location (for example, a branch lane or a merging lane) other than the main lane of the expressway, in order to suppress inadvertent lane changes, the first course change control is inhibited. Then, control is executed in which the second course change control, which is course change control in which the automation rate is lower than in the first course change control or the degree of involvement in vehicle operations required of the driver is increased, is executable.

In S106, the vehicle control apparatus 13 determines whether the operation mode of the vehicle 1 continues the automated driving mode. If the automated driving mode is continued, the process returns to S102. Otherwise, this procedure is terminated. Thus, a series of processing of FIG. 3 is completed.

As has been described above, in this embodiment, based on whether the vehicle is traveling on the main lane of the expressway, whether to execute the first course change control and the second course change control is controlled. More specifically, if the vehicle is traveling on the main lane, both the first course change control and the second course change control are set to be executable, and if the vehicle is traveling on a location (such as a branch lane or a merging lane) other than the main lane, in order to suppress inadvertent lane changes, only the second course change control in which the automation rate is relatively low or the degree of involvement in vehicle operations required of the driver is relatively increased is set to be executable.

With this arrangement, inadvertent lane changes can be suppressed, so that it becomes possible to implement adaptive automated driving with further improved safety.

Note that, in this embodiment, the example in which whether the vehicle 1 is traveling on the main lane of an expressway is determined has been described, but it is not limited to an expressway. For an arbitrary road other than an expressway, simple determination as to whether the vehicle is traveling on the main lane may be performed and whether to execute the first course change control and/or the second course change control may be determined in accordance with the determination result. In addition, determination as to whether the vehicle 1 is located in a specific area such as an expressway or a motorway may be further performed, and determination as to whether the vehicle 1 is traveling on the main lane of a road in the specific area may be performed. The specific area may be an area along the guide route to a destination if the destination is set (a route with a destination), or may be an area of a predetermined range along the current traveling route when no destination is set (a route along the road).

In addition, if the vehicle 1 exits the expressway while the second traveling control is executed, the vehicle control apparatus 13 may cause transition from the second traveling control to the first traveling control. Note that if the vehicle has returned to the specific area, the vehicle control apparatus 13 may cause transition from the first traveling control to the second traveling control again. Thus, the automation rate is decreased after the vehicle exits the expressway, but the automation rate can be subsequently increased again after returning to an expressway.

In the second traveling control in this case, in order to moderately increase the automation rate, both the first course change control and the second course change control may be suppressed. Here, the term “suppress” means, for example, that the course change control cannot be executed until a predetermined time elapses, until the vehicle travels a predetermined distance, or until a user instruction is accepted. Instead of suppressing both, the first course change control with a higher automation rate may be suppressed and the second course change control may be permitted. This can suppress a course change in an unstable state immediately after returning to an expressway, so that safer automated driving can be implemented. If both the first course change control and the second course change control are suppressed, the vehicle control apparatus 13 may perform main lane determination, and then execute control in which both the first course change control and the second course change control are executable or one (the second course change control) of them is executable.

According to this embodiment, it becomes possible to implement adaptive automated driving with further improved safety.

### Other Embodiments

A vehicle control program that implements one or more functions described in each embodiment is supplied to a system or an apparatus via a network or a storage medium, and one or more processors in the computer of the system or the apparatus can read out and execute this program. The present invention can also be implemented by such a mode.

### Summary of Embodiments

Arrangement 1. The vehicle control apparatus according to the above-described embodiment is a vehicle control apparatus (for example, 13) that controls a vehicle (for example, 1), comprising

acquisition means (for example, 134) for acquiring peripheral information of the vehicle, and

control means (for example, 131 to 133) for controlling traveling of the vehicle based on the peripheral information,

wherein the control means determines whether the vehicle is traveling on a main lane,

if the vehicle is traveling on a main lane, executes control in which both first course change control and second course change control in which an automation rate is lower than in the first course change control or a degree of involvement in vehicle operations required of a driver is increased are executable, and

if the vehicle is not traveling on the main lane, executes control in which the second course change control is executable but the first course change control is not executable.

With this arrangement, inadvertent lane changes can be suppressed when the vehicle is not traveling on the main lane (for example, when the vehicle is traveling on a branch lane or a merging lane), so that it becomes possible to implement adaptive automated driving with further improved safety.

Arrangement 2. In the vehicle control apparatus according to the above-described embodiment,

the control means further determines whether the vehicle is located in a specific area,

if the vehicle is located in the specific area and traveling on a main lane, executes control in which both the first course change control and the second course change control are executable, and

if the vehicle is located in the specific area but not traveling on a main lane, executes control in which the second course change control is executable but the first course change control is not executable.

With this arrangement, inadvertent lane changes can be suppressed when the vehicle is not traveling on a main lane (for example, when the vehicle is traveling on a branch lane or a merging lane) in a specific area (such as an expressway or a motorway), so that it becomes possible to implement adaptive automated driving with further improved safety.

Arrangement 3. In the vehicle control apparatus according to the above-described embodiment, the specific area is one of an area along a guide route to a destination if the destination is set, and an area of a predetermined range along a current traveling route if the destination is not set.

With this arrangement, the area can be set in consideration of the destination, so that vehicle control can be executed in the area according to driver's intention. In addition, even if the destination is not set, the area can be set in consideration of the current traveling route, so that vehicle control can be executed in the area close to driver's intention.

Arrangement 4. In the vehicle control apparatus according to the above-described embodiment,

the control means can execute one of first traveling control and second traveling control in which an automation rate is higher than in the first traveling control or a degree of involvement in vehicle operations required of a driver is decreased, and

the control means causes transition to the first traveling control if the vehicle has gone out of the specific area during the second traveling control, and

causes transition from the first traveling control to the second traveling control again if the vehicle has returned to the specific area.

With this arrangement, even after the vehicle has gone out of the specific area (for example, an expressway, a motorway, or the like) and the automation rate of automated driving has decreased, it is possible to increase the automation rate again by user's intention.

Arrangement 5. In the vehicle control apparatus according to the above-described embodiment, the control means suppresses the first course change control and the second course change control if the vehicle has transitioned from the second traveling control to the first traveling control in accordance with a case in which the vehicle has gone out of the specific area, and transitioned from the first traveling control to the second traveling control again in accordance with a case in which the vehicle has returned to the specific area.

With this arrangement, a course change in an unstable state immediately after returning to the specific area again can be suppressed, so that safer automated driving can be implemented.

Arrangement 6. In the vehicle control apparatus according to the above-described embodiment, the main lane is a traffic lane other than one of a branch lane from the main lane and a merging lane to the main lane.

With this arrangement, control in which only the second course change control is executable is executed while the vehicle is traveling on a branch lane or a merging lane, so that inadvertent lane changes can be suppressed, and it becomes possible to implement adaptive automated driving with further improved safety.

Arrangement 7. In the vehicle control apparatus according to the above-described embodiment,

the first course change control is an automated lane change executed by determination of the vehicle control apparatus, and

the second course change control is an automated lane change executed by the vehicle control apparatus in accordance with a user instruction.

With this arrangement, it is possible to adaptively control whether to execute an automated lane change executed by determination of the vehicle control apparatus and whether to execute an automated lane change executed in accordance with a user instruction.

Arrangement 8. The vehicle according to the above-described embodiment is a vehicle (for example, 1) comprising a vehicle control apparatus defined in any one of arrangement 1 to 7.

With this arrangement, in the vehicle, it becomes possible to implement adoptive automated driving with further improved safety.

Arrangement 9. The vehicle control method according to the above-described embodiment is a vehicle control method of controlling a vehicle (for example, 1), the method comprising

an acquisition step of acquiring peripheral information of the vehicle, and a control step of controlling traveling of the vehicle based on the peripheral information,

wherein in the control step, it is determined whether the vehicle is traveling on a main lane,

if the vehicle is traveling on a main lane, control is executed in which both first course change control and second course change control, in which an automation rate is lower than in the first course change control or a degree of involvement in vehicle operations required of a driver is increased, are executable, and

if the vehicle is not traveling on the main lane, control is executed in which the second course change control is executable but the first course change control is not executable.

With this arrangement, inadvertent lane changes can be suppressed when the vehicle is not traveling on the main lane (for example, when the vehicle is traveling on a branch lane or a merging lane), so that it becomes possible to implement adaptive automated driving with further improved safety.

Arrangement 10. A program according to the above-described embodiment is a program for causing a computer to function as a vehicle control apparatus (for example, 13) defined in any one of arrangement 1 to 7.

With this arrangement, the processing of the vehicle control apparatus can be implemented by a computer.

The invention is not limited to the foregoing embodiments, and various variations/changes are possible within the spirit of the invention.

What is claimed is:

1. A vehicle control apparatus that controls a vehicle, comprising:
an acquisition unit configured to acquire peripheral information of the vehicle; and
a control unit configured to control traveling of the vehicle based on the peripheral information,
wherein the control unit determines whether the vehicle is traveling on a main lane,
if the vehicle is traveling on a main lane, executes control in which both first course change control and second course change control, in which an automation rate is lower than in the first course change control or a degree of involvement in vehicle operations required of a driver is increased, are executable, and
if the vehicle is not traveling on the main lane, executes control in which the second course change control is executable but the first course change control is not executable.

2. The apparatus according to claim 1, wherein
the control unit further determines whether the vehicle is located in a specific area,
if the vehicle is located in the specific area and traveling on a main lane, executes control in which both the first course change control and the second course change control are executable, and
if the vehicle is located in the specific area but not traveling on a main lane, executes control in which the second course change control is executable but the first course change control is not executable.

3. The apparatus according to claim 2, wherein the specific area is one of an area along a guide route to a destination if the destination is set, and an area of a predetermined range along a current traveling route if the destination is not set.

4. The apparatus according to claim 2, wherein
the control unit can execute one of first traveling control and second traveling control in which an automation rate is higher than in the first traveling control or a degree of involvement in vehicle operations required of a driver is decreased, and
the control unit causes transition to the first traveling control if the vehicle has gone out of the specific area during the second traveling control, and
causes transition from the first traveling control to the second traveling control again if the vehicle has returned to the specific area.

5. The apparatus according to claim 4, wherein the control unit suppresses the first course change control and the second course change control if the vehicle has been transitioned from the second traveling control to the first traveling control in accordance with a case in which the vehicle has gone out of the specific area and transitioned from the first traveling control to the second traveling control again in accordance with a case in which the vehicle has returned to the specific area.

6. The apparatus according to claim 1, wherein the main lane is a traffic lane other than one of a branch lane from the main lane and a merging lane to the main lane.

7. The apparatus according to claim 1, wherein
the first course change control is an automated lane change executed by determination of the vehicle control apparatus, and
the second course change control is an automated lane change executed by the vehicle control apparatus in accordance with a user instruction.

8. A vehicle comprising a vehicle control apparatus that controls the vehicle, the vehicle control apparatus comprising:
an acquisition unit configured to acquire peripheral information of the vehicle; and
a control unit configured to control traveling of the vehicle based on the peripheral information,
wherein the control unit determines whether the vehicle is traveling on a main lane,
if the vehicle is traveling on a main lane, executes control in which both first course change control and second course change control, in which an automation rate is lower than in the first course change control or a degree of involvement in vehicle operations required of a driver is increased, are executable, and
if the vehicle is not traveling on the main lane, executes control in which the second course change control is executable but the first course change control is not executable.

9. A vehicle control method of controlling a vehicle, the method comprising:
acquiring peripheral information of the vehicle; and
controlling traveling of the vehicle based on the peripheral information,
wherein in the controlling, it is determined whether the vehicle is traveling on a main lane,
if the vehicle is traveling on a main lane, control is executed in which both first course change control and second course change control, in which an automation rate is lower than in the first course change control or a degree of involvement in vehicle operations required of a driver is increased, are executable, and
if the vehicle is not traveling on the main lane, control is executed in which the second course change control is executable but the first course change control is not executable.

10. A non-transitory computer-readable storage medium storing a program for causing a computer to perform a vehicle control method of controlling a vehicle, the method comprising:
acquiring peripheral information of the vehicle; and
controlling traveling of the vehicle based on the peripheral information,
wherein in the controlling, it is determined whether the vehicle is traveling on a main lane,
if the vehicle is traveling on a main lane, control is executed in which both first course change control and second course change control, in which an automation rate is lower than in the first course change control or a degree of involvement in vehicle operations required of a driver is increased, are executable, and
if the vehicle is not traveling on the main lane, control is executed in which the second course change control is executable but the first course change control is not executable.
